(19) United States
(12) Patent Application Publication
(10) Pub. No.: US 2009/0037988 A1
(43) Pub. Date: Feb. 5, 2009

(54) System and method of mutual authentication with dynamic password

(76) Inventors: Wen-Her Yang, Hsinchu (TW); Yung-Hsiang Liu, Hsinchu (TW); Miller Chang, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/896,783

(22) Filed: Sep. 6, 2007

(30) Foreign Application Priority Data
Jul. 31, 2007 (TW) 096127968

(51) Int. Cl. H04L 9/32

(52) U.S. Cl. 726/6

(57) ABSTRACT

A method of mutual authentication with dynamic password includes: generating a dynamic password and a first validation code by using a password generator; entering the dynamic password into a user interface; and transmitting the dynamic password to a verification host to verify the correctness of the dynamic password, if the dynamic password is correct, returning a second validation code to the user interface for a user to confirm whether the first validation code and the second validation code are the same or not. A system of mutual authentication with dynamic password is also disclosed. The above-mentioned system and method of mutual authentication with dynamic password can reduce the risk of phishing attack.

### FIELD OF THE INVENTION

The present invention relates to a system and a method of mutual authentication with dynamic password. More particularly, the present invention relates to a system and a method of mutual authentication with dynamic password which can reduce the risk of phishing attack.

### DESCRIPTION OF THE PRIOR ART

Accompanying with the progress of the internet technology, such as the e-commerce and the e-government, the lifestyle of the human being is changed gradually. Because of the highly privacy of the internet, the verification of the user identity is an important issue. In conventional verification, user enters his/her account and password to login to the service.

Recently, lots of malice computer skills are spreading and destroying the internet security, such as the computer worms, the Trojan horses, or the backdoor programs. Once the password or the account is stolen, the thief can pretend the user to do an illegal action or embezzle user's property. In order to avoid the steal of the account and the password, a verification technology with the dynamic password has been developed already, such as one-time password (OTP). The one-time password is generated by a password generator according to an algorithm, and the password is invalidated after the user login to the service or a period. Thus, the thief can not use the password to login to the service or to embezzle the user identity.

However, the verification technology of the one-time password still has significant risk when addressing the phishing attack. The scenario of the phishing attack is to create a fake interface, which is the same to the correct interface almost, and to entice the user entering the account and the password into the fake interface, so as to grab the user information. The stolen password is not used to the true interface yet, and the one-time password still is valid, thus the thief can pretend the user.

To sum up the foregoing descriptions, how to achieve the dual-way verification between user and the true interface to recognize the fake user interface and take the appropriate protection action immediately is the most important goal.

### SUMMARY OF THE INVENTION

One object of the present invention is to provide a system and a method of mutual authentication with dynamic password to verify the validity of the verification host and the user identity by a set of dynamic password and a validation code. Thus, the user can differentiate the fake user interface easily and take the effectively action to protect the user information during the verification process.

In accordance with the above object, one embodiment of the present invention provides a system of mutual authentication with dynamic password, and the system includes: a password generator used to generate a dynamic password and a first validation code; a user interface provided to a user for entering the dynamic password; and a verification host signal-connected with the user interface, wherein the verification host can verify the dynamic password, and, if the dynamic password is correct, the verification host will generate and transmit a second validation code to the user interface for the user to confirm the sameness of the first validation code and the second validation code.

In accordance with the above objects, another embodiment of the present invention provides a method of mutual authentication with dynamic password, and the method includes: generating a dynamic password and a first validation code by using a password generator; entering the dynamic password into a user interface; and transmitting the dynamic password to a verification host to verify the dynamic password, and, if the dynamic password is correct, then returning a second validation code to the user interface for the user to confirm whether the first validation code and the second validation code are the same or not.

Other advantages of the present invention will become apparent from the following description taken in conjunction with the accompanying drawings wherein are set forth, by way of illustration and example, certain embodiments of the present invention.

### BRIEF DESCRIPTION OF THE DRAWINGS

The foregoing aspects and many of the accompanying advantages of this invention will become more readily appreciated as the same becomes better understood by reference to the following detailed description, when taken in conjunction with the accompanying drawings, wherein:

FIG. 1 is a block diagram of the system of mutual authentication with dynamic password in accordance with an embodiment of the present invention; and

FIG. 2 is a flow chart of the method of mutual authentication with dynamic password in accordance with an embodiment of the present invention.

### DETAILED DESCRIPTION OF THE INVENTION

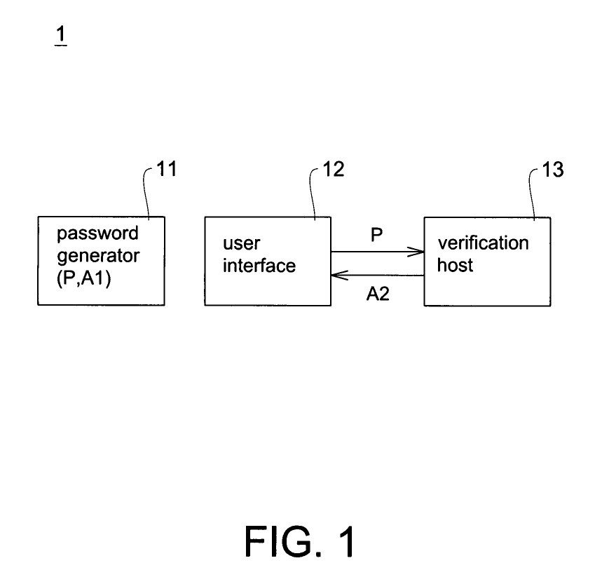

FIG. 1 is a block diagram of the system of mutual authentication with dynamic password I in accordance with an embodiment of the present invention. The system of mutual authentication with dynamic password 1 includes a password generator 11, a user interface 12, and a verification host 13. The password generator 11 is used to generate a dynamic password P and a first validation code A1. For instance, the dynamic password P is a one-time password. The password generator 11 can be an independent device or integrated to other mobile calculation apparatus, such as a cell phone, a personal digital assistant (PDA) or a laptop. In addition, the password generator 11 can be a combination of a mobile storage and a calculation host. Thus, the related parameters, used to generate the dynamic password P, can be saved in the mobile storage, so user can bring it on the go. When the user needs the dynamic password P and the first validation code A1, he/she just electrically connects the mobile storage to the calculation host to generate the dynamic password P and the first validation code A1. For instance, the mobile storage can be a flash memory, such as a pen drive, and the calculation host can be a computer.

Accordingly, the user interface 12 is used to let user enter the dynamic password P which generated by the password generator 11. The verification host 13 is signal-connected with the user interface 12. After the user enters the dynamic password P into the user interface 12, the dynamic password P is transmitted to the verification host 13. Next, the verification host 13 verifies the received dynamic password P, and, if the dynamic password P is correct, the verification host 13 generates a second validation code A2 and returns the second validation code A2 to the user interface 12. The user can confirm whether the first validation code A1, generated by the password generator 11, and the second validation code A2, returned from the verification host 13 are the same or not, so as to make sure the validity of the current user interface. The user interface 12 can be integrated with the verification host 13, or arranged on two different hosts, which are signal-connected each other via the network technology.

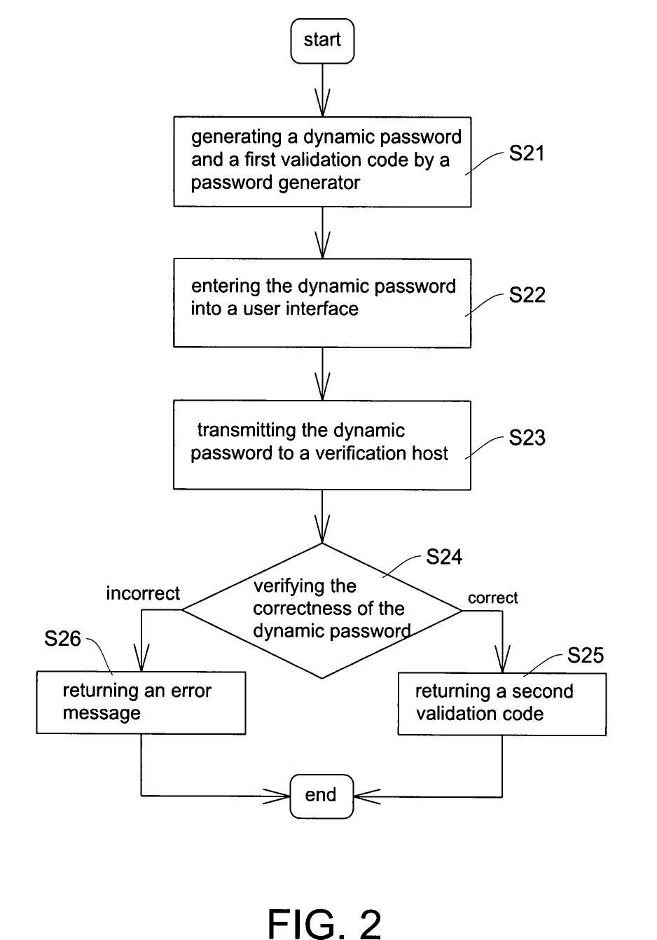

FIG. 2 is a flow chart of the method of mutual authentication with dynamic password in accordance with an embodiment of the present invention. First of all, the password generator 11 generates a dynamic password P and a first validation code A1 (step S21), and the user enters the dynamic password P into a user interface 12 (step S22). Next, the user interface 12 transmits the dynamic password P to the verification host 13 (step S23) and then the verification host 13 will verify the dynamic password P (step S24). If the dynamic password P is correct, then the verification host 13 will return a second validation code A2 to the user interface 12 (step S25) for user to confirm whether the first validation code A1 and the second validation code A2 are the same or not, so the user can justify the validity of the current user interface. In addition, if the dynamic password P is incorrect, the verification host 13 will notify the user of an error message (step S26).

The following embodiment describes how to identify the fake user interface during the verification process. First of all, the user gets a set of dynamic password P and a first validation code A1 from a password generator 11, such as a cell phone, and then enters the dynamic password P into a user interface 12, such as a webpage. Then, the dynamic password P will be transmitted to a verification host 13 for verifying the dynamic password P and the verification host 13 will return a second validation code A2 if the dynamic password P has been verified. If the second validation code A2 is the same to the first validation code A1, the current user interface 12 can be recognized as the valid user interface, so user can proceed to the following actions securely.

Accordingly, if the second validation code A2 is not the same to the first validation code A1, the user can recognize the current user interface 12 as fake, such as a phishing webpage. At this moment, the user can take appropriate protection action, like invalidating the dynamic password P which was entered into the fake user interface. For example, the user can generate a second dynamic password to login to the valid webpage immediately, or informs the system administrator to invalidate the stolen dynamic password P. Thus, the user can recognize whether the user interface is fake or not during the verification process.

To sum up the foregoing descriptions, a system and a method of mutual authentication with dynamic password of the present invention are not only to verify the user identity by the verification host, but also the user can verify the validity of the verification host by the validation codes, so as to achieve the goal of the dual-way verification. Comparing with the conventional one-time password verification method—only verifying the user, the system and the method of mutual authentication with dynamic password of the present invention can reduce the risk of phishing attack.

The foregoing descriptions of specific embodiments of the present invention have been presented for purposes of illustrations and description. They are not intended to be exclusive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to particular use contemplated. It is intended that the scope of the invention be defined by the claims appended hereto and their equivalents.

What is claimed is:

1. A system of mutual authentication with dynamic password, comprising:
a password generator used to generate a dynamic password and a first validation code;
a user interface provided to a user for entering said dynamic password; and
a verification host signal-connected with said user interface, wherein said verification host will verify said dynamic password, and, if said dynamic password is correct, said verification host will generate and transmit a second validation code to said user interface for said user to confirm whether said first validation code and said second validation code are the same or not.

2. The system of mutual authentication with dynamic password according to claim 1, wherein said verification host returns an error message to said user interface when said dynamic password is incorrect.

3. The system of mutual authentication with dynamic password according to claim 1, wherein said dynamic password is a one-time password.

4. The system of mutual authentication with dynamic password according to claim 1, wherein said password generator is a mobile calculation apparatus.

5. The system of mutual authentication with dynamic password according to claim 4, wherein said mobile calculation apparatus includes a cell phone, a personal digital assistant, or a laptop.

6. The system of mutual authentication with dynamic password according to claim 1, wherein said password generator comprises a mobile storage and a calculation host.

7. The system of mutual authentication with dynamic password according to claim 6, wherein said mobile storage includes a flash memory.

8. A method of mutual authentication with dynamic password, comprising:
generating a dynamic password and a first validation code by using a password generator;
entering said dynamic password into a user interface; and
transmitting said dynamic password to a verification host to verify said dynamic password, and, if said dynamic password is correct, then returning a second validation code to said user interface for said user to confirm whether said first validation code and said second validation code are the same or not.

9. The method of mutual authentication with dynamic password according to claim 8, wherein said verification host returns an error message to said user interface when said dynamic password is incorrect.

10. The method of mutual authentication with dynamic password according to claim 8, wherein said dynamic password is a one-time password.

11. The method of mutual authentication with dynamic password according to claim 8, wherein said password generator is a mobile calculation apparatus.

12. The method of mutual authentication with dynamic password according to claim 11, wherein said mobile calculation apparatus includes a cell phone, a personal digital assistant, or a laptop.

13. The method of mutual authentication with dynamic password according to claim 8, wherein said password generator comprises a mobile storage and a calculation host.

14. The method of mutual authentication with dynamic password according to claim 13, wherein said mobile storage includes a flash memory.
